(19) United States
(12) Patent Application Publication
(10) Pub. No.: US 2012/0102834 A1
(43) Pub. Date: May 3, 2012

(54) STAGED GASIFIER AND RELATED PROCESSES

(75) Inventors: Surinder Prabhjot Singh, Tustin, CA (US); Vitali V. Lissianski, Schenectady, NY (US); Aaron John Avagliano, Houston, TX (US); Wolfgang Madl, Axams (AT)

(73) Assignee: GENERAL ELECTRIC COMPANY, Schenectady, NY (US)

(21) Appl. No.: 12/916,219

(22) Filed: Oct. 29, 2010

(51) Int. Cl. B01J 7/00; C10J 3/00

(52) U.S. Cl. 48/61; 48/197 R; 48/210

(57) ABSTRACT

A gasifier system which includes a reactor; a feedstock inlet; an oxidant inlet; a raw product gas outlet; and a recycle conduit, is provided. The reactor usually includes an upper section, a central section, and a lower section. The feedstock inlet is disposed in the upper section of the reactor to receive a carbonaceous feedstock. The oxidant inlet is disposed in the lower section of the reactor to receive an oxidant. The raw product gas outlet is disposed in the upper section of the reactor. The recycle conduit is configured to couple the raw product gas outlet to the lower section of the reactor, and to recycle a raw product gas from the upper section of the reactor to the lower section of the reactor. A method for converting a carbonaceous stream into a product gas in a gasifier system is also provided.

### BACKGROUND

The invention relates to a gasifier system and a method of treating a carbonaceous material.

Utilization of biomass for energy production, along with other renewable fuels, is considered to be one of the approaches to mitigate increasing CO₂ concentration in the atmosphere. Plants consume carbon dioxide from the environment during their growth. If biomass is utilized in gasification, the amount of CO₂ released in the environment due to gasification corresponds to the amount of CO₂ consumed during the growth of plants. Thus, gasification or combustion of plant biomass does not add extra CO₂ to the environment. Therefore, the use of biomass is considered “carbon-neutral”.

Many types of raw materials and feedstocks have been used in gasification operations. Examples include hydrocarbon-based materials, such as oil, coal, refinery residuals, and sewage sludge. In the gasification process, carbonaceous materials, such as coal, petroleum, or biomass, are converted into gases, such as carbon monoxide and hydrogen, by reacting the raw material at high temperatures, with a controlled amount of oxygen. When gasified, the carbon containing feedstock, or “feed”, would form a resulting gas mixture referred to as synthesis gas or “syngas”, which is itself a very useful fuel.

Generally, the gasification process consists of feeding carbon-containing materials into a heated chamber, along with a controlled and limited amount of oxygen and steam. One of the major disadvantages in biomass gasification is that the syngas that is formed may have a high tar concentration, which tends to condense upon cooling, and plug the gasifier system. Moreover, the integration of biomass gasification with internal combustion engines and turbines, e.g., for electricity production, requires syngas with low tar content. Therefore, an extensive syngas clean-up is required, prior to being utilized for energy production.

Prior attempts to decrease tar in the syngas are primarily divided into two main categories i) removal of the tar within the gasifier vessel; and (ii) removal of the tar in a reactor outside the gasifier vessel. However, the two methods often are accompanied by drawbacks, such as low selectivity for desired products; and cost ineffectiveness. An alternate means of tar reduction has been to employ water scrubbers that require the addition of a water purification system. This can add to the cost and complexity of the process. In other instances, downdraft gasifiers have been employed to obtain syngas with low tar content. However, the use of these types of gasifiers may be accompanied by scale-up problems and reliability issues over a period of time, e.g., due to channeling of the syngas from the char bed.

Therefore, there is a continuing need for a method for the treatment of carbonaceous material that can optimize heating conditions, while producing a relatively high yield of the product gas, with low tar content. Further, there exists a need for a process to more efficiently utilize the catalytic activity of char to decompose the tar, thereby leading to low-tar syngas. At a minimum, in order to be commercially viable, such technology would desirably be utilized at a relatively low cost, and would also utilize a carbonaceous material to obtain syngas in relatively high yields.

### BRIEF DESCRIPTION

One aspect of the present invention provides a gasifier system which is configured to gasify a carbonaceous feedstock, said system comprising a reactor which includes at least one feedstock inlet and at least one raw product gas outlet, and further comprising a recycle conduit which is configured to recycle raw product gas exiting from one section of the reactor, for entry into another section of the reactor. In some embodiments, the gasifier system comprises a reactor; a feedstock inlet; an oxidant inlet; a raw product gas outlet; and a recycle conduit. The reactor includes an upper section, a central section, and a lower section. The feedstock inlet is disposed in the upper section of the reactor, to receive a carbonaceous feedstock. The oxidant inlet is disposed in the lower section of the reactor, to receive an oxidant. The raw product gas outlet is disposed in the upper section of the reactor. The recycle conduit is configured to couple the raw product gas outlet to the lower section of the reactor, and recycle a raw product gas from the upper section of the reactor to the lower section of the reactor.

Another aspect of the present invention provides a method for converting a carbonaceous stream into a product gas in a gasifier system. The method includes providing a carbonaceous feedstock via an inlet disposed in an upper section of a reactor; providing an oxidant via an oxidant inlet disposed in a lower section of the reactor; reacting the stream of carbonaceous feedstock and the oxidant to form a mixture comprising raw product gas, product gas, and solid particulates; transferring the raw product gas via a raw product gas outlet disposed at the upper section of the reactor to the recycle conduit; recycling at least a portion of the raw product gas to the reactor via the recycle conduit; and transferring the product gas via at least one product gas outlet located in a central section of the reactor.

### BRIEF DESCRIPTION OF THE DRAWINGS

These and other features, aspects, and advantages of the present invention will become better understood when the following detailed description is read, with reference to the accompanying drawings, in which like characters represent like parts throughout the drawings, wherein:

FIG. 1 is a schematic representation of the gasifier system according to an embodiment of the invention.

FIG. 2 is a schematic representation of the gasifier system according to another embodiment of the invention.

### DETAILED DESCRIPTION

While only certain features of the invention have been illustrated and described herein, many modifications and changes will occur to those skilled in the art. It is, therefore, to be understood that the appended claims are intended to cover all such modifications and changes as fall within the true spirit of the invention. In the specification and claims, reference will be made to a number of terms, which have the following meanings.

The singular forms “a”, “an” and “the” include plural referents unless the context clearly dictates otherwise. Approximating language, as used herein throughout the specification and claims, may be applied to modify any quantitative representation that could permissibly vary, without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term.

As used herein, the terms “may” and “may be” indicate a possibility of an occurrence within a set of circumstances; a possession of a specified property, characteristic or function; and/or may qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances, an event or capacity can be expected, while in other circumstances, the event or capacity cannot occur—this distinction is captured by the terms “may” and “may be”.

“Optional” or “optionally” means that the subsequently described event or circumstance may or may not occur, and that the description includes instances where the event occurs, and instances where it does not.

As previously noted, in one embodiment, the present invention provides a gasifier comprising a reactor; a feedstock inlet; an oxidant inlet; a raw product gas outlet; and a recycle conduit. (As used herein, the “raw product gas” is the source of the recycle stream, as compared to the “final” product gas). The reactor includes an upper section, a central section, and a lower section. The feedstock inlet is disposed in the upper section of the reactor, to receive a carbonaceous feedstock. The oxidant inlet is disposed in the lower section of the reactor, to receive an oxidant. The raw product gas outlet is disposed in the upper section of the reactor. The recycle conduit is configured to couple the raw product gas outlet to the lower section of the reactor, and to recycle a raw product gas from the upper section of the reactor to the lower section of the reactor. In some embodiments the product gas e.g. syngas, has a tar content of less than about 1% by weight based on the weight of the gasification product and is directed out of the reactor from the central section. The syngas product can be used for a variety of purposes, e.g., as a fuel, or as an intermediate for the production of a number of other fuels, via the Fischer-Tropsch process.

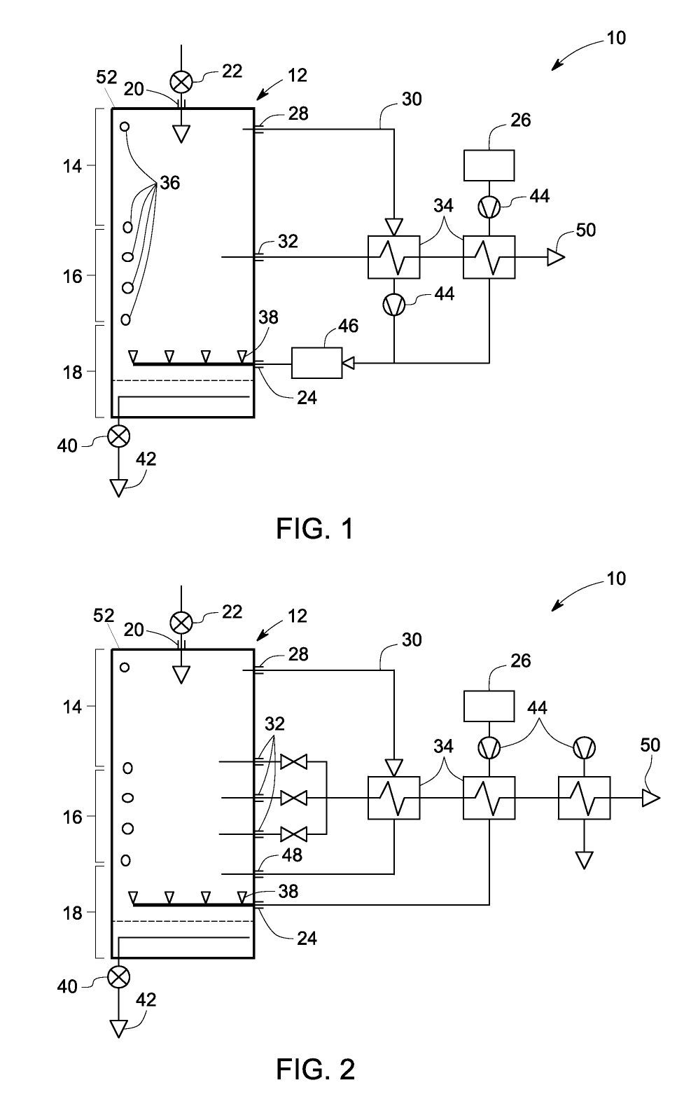

Referring to the drawings, identical reference numerals denote the same elements throughout the various views. A schematic representation of the gasifier system according to an embodiment of the invention is depicted in FIG. 1. Referring to FIG. 1, the gasifier 10 includes a reactor 12. Typically, the reactor 12 is a reaction vessel suitable for gasification of the feedstock. The choice of reactors, based on factors such as gas velocities and configurations, may typically be fixed bed, fluidized bed or entrained flow reactors, or some variation of these. An exemplary reactor with some of these features is described in the pending U.S. patent application Ser. No. 12/209,011, filed on Sep. 11, 2008, which is incorporated herein by reference. The types and extent of reactions in a reactor depends upon design and operating conditions in the reactor. In one embodiment, the reactor 12 is a fixed bed reactor. The reactor 12 usually comprises three sections (also sometimes referred to as “zones”): an upper section 14, a central section 16, and a lower section 18. The term “zone” or “section”, as used herein, refers to a region of the reactor 12. The terms may be used interchangeably in this description. The zones are not physically separated by any mechanical means, such as a separation baffle, unless specifically noted.

The location of the zones or sections in the reactor 12 depends, in part, on the relative movement of the feedstock and the oxidant. These sections are differentiated by the variety of reactions or processes occurring, and the temperature regimes at those locations. Thus, a zone or section usually corresponds to a processing region within the reactor 12. The zone may further include sub-zones or regions that include, for example, typical unit processes and operations involved in gasification, such as drying, devolatilization and oxidation reactions. These sub-zones may be overlapping with each other. The zones or sections, on the other hand, may be fairly distinct. In some embodiments, there is a partial overlap of the successive sections. Typically, the lower section 18 of the reactor 12 constitutes at least about 10 percent (10%) in height from the bottom of the reactor 12. In one embodiment, the lower section 18 is the oxidation/combustion zone of the reactor 12. In one embodiment, the central section 16 is at least about 40 percent (40%) in height from the lower section 18 of the reactor 12, while the upper section 14 (also sometimes referred to as the devolatilization or drying zone) forms at least about 50 percent (50%) of the reactor 12, as measured from the top 52 of the reactor 12. The reactor 12 includes a feedstock inlet 20, which is disposed in the upper section 14 of the reactor. The feedstock inlet 20 typically introduces the feedstock into the reactor 12, and can be positioned in a variety of locations, at or near the top 52 of the reactor.

In one embodiment, the feedstock that is directed into inlet 20 is a carbonaceous feedstock, such as coal, or a material comprising coal. Coal is a common fossil fuel. There are various types of coals, and most of the common classification is based on the calorific value and composition of the coal. ASTM (American Society for Testing and Materials) standard D388 classifies the coals by rank. This is based on properties such as fixed carbon content, volatile matter content, calorific value, and agglomerating character. Broadly, the coals can be categorized as “high rank coal” and “low rank coal”. The first term denotes high-heating-value and lower ash content, while the second term denotes lower heating value and higher ash content. Low-rank coals include lignite and sub-bituminous coals. These coals have lower energy content and higher moisture levels. High-rank coals, including bituminous and anthracite coals, contain more carbon than lower-rank coals, and correspondingly have a much higher energy content. Some coals with intermediate properties may be termed as “medium rank coal.”

In another embodiment, the feedstock comprises biomass. As used herein the term “biomass” covers a broad range of materials that offer themselves as fuels or raw materials, and are characterized by the fact that they are derived from recently living organisms (plants and animals). This definition clearly excludes traditional fossil fuels, since although they are also derived from plant (coal) or animal (oil and gas) life, it has taken millions of years to convert them to their current form. Thus, the term biomass includes feedstock derived from tree-based materials such as wood, woodchips, sawdust, bark, seeds, straw, grass, and the like; agricultural and forestry wastes; forest residues, agricultural residues; and energy crops. Agricultural residues and energy crops may further include short rotation herbaceous species, husks such as rice husk, coffee husk etc., maize, corn stover, oilseeds, residues of oilseed extraction, cellulosic fibers like coconut, jute, and the like. The oilseeds may be typical oil bearing seeds like soybean, camolina, canola, rapeseed, corn, cottonseed, sunflower, safflower, olive, peanut, and the like.

Agricultural residues also include materials obtained from agro-processing industries such as deoiled residue. Specific examples include a deoiled soybean cake, deoiled cottonseed, deoiled peanut cake, and the like, and gums from the oil processing industry, such as gum separated from the vegetable oil preparation process. These examples include lecithin in the case of soybean; bagasse (from the sugar processing industry), cotton gin trash, and the like. Biomass also includes other wastes from such industries, such as coconut shell, almond shell, walnut shell, sunflower shell, and the like. In addition to these wastes from agro industries, biomass may also include wastes from animals and humans. In some other embodiments, the term biomass includes animal farming byproducts such, as piggery waste or chicken litter. The term “biomass” may also include algae, microalgae, and the like. In one embodiment, the feedstock may comprise a mixture of coal and biomass. In one embodiment, the ratio of the coal:biomass in the feedstock may be in a range from about 0 to 1.

In one embodiment, the gasifier 10 further includes at least one valve 22, which is used to regulate the flow of the feedstock into the reactor 12, via the feedstock inlet 20. In one embodiment, the gasifier 10 may comprise a feed hopper (not shown) that contains the carbonaceous feedstock to be treated, and a screw feeder (not shown) that pushes the carbonaceous feedstock into the reactor 12. In one embodiment, the carbonaceous feedstock may be ground to smaller particles in a grinder or shredder, prior to being fed into the screw feeder. Moreover, the carbonaceous feedstock may be heated in a pre-heater, prior to entering the reactor 12.

The reactor 12 includes an oxidant inlet 24, usually disposed in the lower section 18 of the reactor. The oxidant inlet 24 is configured to receive an oxidant 26. As used herein, the term “disposed in” refers to the inlet or outlet extending directly through the wall of the reactor 12, or through any type of protrusion, housing, or valve that is disposed on the inner or outer surfaces of the reactor 12.

In one embodiment, the oxidant 26 is at least one selected from air, oxygen; air enriched with oxygen, air depleted of oxygen; carbon dioxide, steam, synthetic mixtures of oxygen and one or more gases, and the like. In another embodiment, the oxidant 26 is selected from air, oxygen, oxygen-enriched air, oxygen-depleted air, or a mixture of air and steam. In yet another embodiment, the oxidant 26 is oxygen itself. In one embodiment, the feedstock and the oxidant move in a counter-current direction inside the reactor 12. Typically, as the carbonaceous feedstock descends from the upper section 14 to the lower section 18 of the reactor 12, it encounters the oxidant 26 moving from the lower section 18 to the upper section 14 of the reactor 12. As shown in the illustrated embodiment, the oxidant 26 passes through an expander 44 and a heat exchanger 34 prior to entering the lower section 18 of the reactor 12. The carbonaceous feedstock descends through the drying sub zone, pyrolysis sub-zone and the gasification/oxidation subzone, each zone progressively increasing in temperature. As the feedstock enters the reactor 12 via the feedstock inlet 20, it typically undergoes drying and devolatilization/pyrolysis. Upon devolatilization, the carbonaceous feedstock decomposes into a mixture which comprises char, light hydrocarbons (e.g., methane, propane, alkenes, propenes, and the like), CO, CO₂, and heavier hydrocarbons, which include tar and oil. (The mixture may also include various other components, like aldehydes, ketones, esters, phenols, and the like).

At this stage, the solid materials in the devolatilization product mixture, such as char and ash, generally descend into the lower zone (18) of the reactor, while the gaseous products generally move upward through the reactor, into upper section 14. Char and ash products moving downwardly in the reactor can react with the gas stream which originated in lower section 18 (the combustion zone). This gas stream usually includes oxygen, carbon dioxide, and steam, as well as the recycled product gas which originated in the drying/devolatilization zone. The reaction of the gas stream with char and ash products results in the formation of a final product gas, having a reduced level of the tar and char. Any remaining char product can be used for various purposes, e.g., as a fertilizer—especially when the feedstock is made up of significant amounts of biomass.

Subsequently, the devolatilized, carbonaceous feedstock enters the gasification zone, where the feedstock reacts with the oxidant 26, to produce a mixture comprising raw product gas, product gas (also known as “synthesis gas” or “syngas”), and solid particulates (including tar and char). (Synthesis gas or syngas is a mixture of gases, containing carbon monoxide (CO) and hydrogen (H₂)). In one embodiment, gasification occurs is the central section 16 of the reactor 12, wherein the carbonaceous feedstock is treated with the oxidant 26.

Gasification involves a number of reactions, including various oxidation reactions,

C+½O₂═CO

CO+½O₂═CO₂

H₂+½O₂═H₂O

the Boudouard reaction,

C+CO₂ [symbol] 2CO

the water gas or steam gasification reaction,

C+H₂O [symbol] CO+H₂

the water-gas shift reaction,

CO+H₂O [symbol] CO₂+H₂

and the methanation reaction

C+2H₂ [symbol] CH₄

For high-rank coals that have a low, inherent oxygen content, the gasification process can be represented as

CₙHₘ+n/2O₂ [symbol] nCO+m/2H₂ (Reaction 1)

Typically, for high rank coals, the values for “n” and “m” in Reaction 1 are as follows: n=1 (or approximately 1), and 0.5<m<1. Steam injection is often used to control the gasification temperature of the high-rank fuels, and to increase the hydrogen content of the product gas, e.g., via a water-gas shift reaction.

A typical biomass compound (or mixture of compounds) can be represented as CₓH_{y}O_{z}, where x is approximately 1, y is approximately 2, and z is approximately 1. The gasification process of such compounds can be generically represented as

CH₂O [symbol] CO+H₂ (Reaction 2)

It can be seen that the oxygen content of the biomass can be advantageously used to minimize the amount of the externally added oxidant (e.g., comparing Reaction 1 and Reaction 2). However, in order for the biomass gasification to proceed accordingly to Reaction 2, additional heat must be supplied. It should be appreciated that some portion of the gasification reactions may also occur in the lower section 18 of the reactor.

Temperatures (during operation) in the central section 16 are usually (though not always) at least about 600° C. In another embodiment, the temperature of the central section 16, wherein the carbonaceous feedstock is treated with the oxidant 26, is in a range from about 600° C. to about 1100° C. In one embodiment, the reactor 12 may further include one or more integrated heating devices (not shown), such as plasma arc torches, so as to maintain a desired temperature. In one embodiment, the reaction of the carbonaceous feedstock and the oxidant is carried out at a pressure of less than about 5 atmospheres. In another embodiment, the reaction of the carbonaceous feedstock and the oxidant is carried out at a pressure in a range from about 1 to about 5 atmospheres. In another embodiment, the reaction of the carbonaceous feedstock and the oxidant is carried out at ambient pressure. The choice of a pressure range will depend on various factors, such as reactor design (e.g., the location of the product gas stream, relative to the dimensions of the reactor); as well as the specific type of feedstock being gasified. In some preferred embodiments, the pressure range is at or near ambient pressure, e.g., about 1 atmosphere. However, higher pressure levels are sometimes desirable, because they can promote the efficient introduction of the recycle stream into the gasifier, while also maintaining the desired direction of flow within the gasifier.

The heat dispersed from the central section 16 is usually transferred by forced convection and radiation upwards, into the upper section 14, which comprises the drying and devolatilization subzones, thereby providing heat required for the various processes. The raw product gas, tar, and volatiles substantially disperse at the upper section 14 of the reactor 12, while the solid particulates 42 (sometimes referred to as “tar” or “ash”), formed as a byproduct of the treatment of the feedstock, accumulate in the lower section 18 of the reactor. In certain embodiments, the reactor 12 includes a grid disposed in the lower section 18, which may act as a filter or sieve to remove the solid particulates. In one embodiment, the reactor 12 further includes an outlet 40 for the solid particulates 42. The outlet 40 for the solid particulates 42 may be disposed in the lower section 18 of the reactor 12, but its precise location is not critical.

In some embodiments, the reactor 12 further includes a plurality of injectors 38, positioned in a location (or multiple locations), such that they direct the oxidant 26 into the reactor 12. In another embodiment, the plurality of injectors 38 direct the flow of the recycled product gas into the reactor 12. In some embodiments the reactor 12 may further include a separate injector for the injection of steam. Since steam has a relatively high thermal capacity, it is useful as a moderator to reduce the temperature around the injector. In addition, steam injection leads to lower gas temperatures throughout the gasifier volume, due to an endothermic water-gas shift reaction.

The reactor 12 includes a raw product gas outlet 28, disposed in the upper section 14 of the reactor 12. Typically, “raw product gas” refers to a mixture of product gases, along with tar. In one embodiment, the raw product gas comprises greater than about 20% tar. In another embodiment, the raw product gas comprises tar in a range from about 1 percent to about 20 percent. The raw product gas thus formed, as a result of reacting the feedstock with the oxidant, can be removed from the reactor 12, via the raw product gas outlet 28.

In one embodiment, the reactor 12 includes a recycle conduit 30, configured to couple the raw product gas outlet 28 to the lower section 18 of the reactor 12. In another embodiment as illustrated in FIG. 2, the recycle conduit 30 is configured to couple the raw product gas outlet 28 to a raw product gas inlet 48. In one embodiment, the raw product gas inlet 48 is disposed in the lower section 18 of the reactor 12. In another embodiment, the raw product gas inlet 48 is disposed in the reactor 12 at a height less than about 20 percent from the bottom of the reactor 12.

In one embodiment, the raw product gas and the oxidant 26 may be premixed prior to entering the reactor 12. In another embodiment shown in FIG. 2, the raw product gas and the oxidant may be introduced into the reactor 12 separately, via the raw product gas inlet 48 and the oxidant inlet 24, respectively. In some embodiments, the mixture of the raw product gas and the oxidant 26 may be fed into a partial oxidation unit 46, prior to being introduced into the reactor 12. In one embodiment, the char formed as a result of the reaction of the carbonaceous feedstock may act as a catalyst to decompose the tar in the raw product gas introduced in the reactor 12, at the lower section 18.

In one embodiment, the reactor 12 includes at least one product gas outlet 32, generally disposed in the central section 16 of the reactor. Typically, the product gas is discharged from the reactor 12 via the product gas outlet 32. In one embodiment, the product gas is discharged from the reactor 12 via the at least one product gas outlet 32, at a temperature in a range from about 800° C. to about 1100° C. In another embodiment, the product gas is discharged from the reactor 12 via the at least one product gas outlet 32, at a temperature of about 850° C. to about 950° C. In one embodiment, the at least one product gas outlet 32 is located in the central section 16 of the reactor 12.

With reference to FIGS. 1 and 2, the gasifier can optionally include at least one heat exchange unit 34, located downstream of the reactor 12. In one embodiment, the raw product gas is in thermal contact with the product gas exiting the reactor 12 through the heat exchange unit 34. In an illustrative embodiment (FIG. 1) the product gas 50, exiting the reactor 12, is in thermal contact with the oxidant 26, via the heat exchange unit 34. As used herein, the term “thermal contact” refers to the transfer of heat across a heat transmissive barrier, such as the wall of a heat exchange unit. The product gas exiting the reactor 12 allows for the recovery of the heat from the heat exchange unit 34, which can be used to preheat the oxidant 26 and/or the raw product gas, thereby increasing the overall efficiency of the gasifier system 10.

In one embodiment, the reactor 12 may include at least one sensor 36 (e.g., see FIG. 1), to measure various parameters of the feedstock, and to monitor the conditions in the reactor 12. In one embodiment, the sensor 36 is selected from pressure sensors, temperature sensors, oxygen sensors, and combinations thereof. Where a composition is being measured, the measurements may be made continuously by using online measurement systems. Alternatively, the measurements may be made by sampling at regular intervals, and performing an offline analysis of the samples. In some other embodiments, indirect measurements, also referred to as a “soft sensing” approach, may be used. In yet another embodiment, the sensor 36 is configured to measure the temperature inside the reactor. In another embodiment, a controller is configured to take the measured parameters as inputs, and to control the injection of at least one of the carbonaceous feedstock, oxidant, or raw product gas, into the reactor 12. In one embodiment, the sensor 36 may be located anywhere in the reactor 12. Typically, the sensors 36 are positioned in locations which permit the measurement of the desired property. Those skilled in the art will be familiar with the most appropriate location for each sensor.

Another aspect of the invention is directed to a method for converting a carbonaceous stream into a product gas in a gasifier system. The method includes providing a carbonaceous feedstock via an inlet disposed in an upper section of a reactor; providing an oxidant via an oxidant inlet disposed in a lower section of the reactor; reacting the stream of carbonaceous feedstock and the oxidant to form a mixture comprising raw product gas, product gas, and solid particulates; transferring the raw product gas via a raw product gas outlet disposed at the upper section of the reactor to the recycle conduit; recycling at least a portion of the raw product gas to the reactor via a recycle conduit; and transferring the product gas, via at least one product gas outlet located in a generally central section of the reactor.

This written description uses illustrations to disclose some embodiments of the invention, including the best mode, and also to enable any person skilled in the art to practice the invention, including making and using any devices or systems, and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A gasifier system, comprising:
a reactor having an upper section, a central section, and a lower section;
a feedstock inlet disposed in the upper section of the reactor, to receive a carbonaceous feedstock;
an oxidant inlet disposed in the lower section of the reactor, to receive an oxidant;
a raw product gas outlet disposed in the upper section of the reactor; and
a recycle conduit configured to couple the raw product gas outlet to the lower section of the reactor, and to recycle a raw product gas from the upper section of the reactor to the lower section of the reactor.

2. The gasifier system according to claim 1, wherein the at least one product gas outlet is disposed in the central section of the reactor.

3. The gasifier system according to claim 1, further comprising a heat exchange unit located downstream of the reactor.

4. The gasifier system according to claim 1, wherein the reactor further comprises sensors selected from pressure sensors, temperature sensors, oxygen sensors, and combinations thereof.

5. The gasifier system according to claim 1, wherein at least one of the sensors is configured to measure the temperature inside the reactor.

6. The gasifier system according to claim 1, wherein the reactor further comprises a plurality of injectors positioned in locations which permit them to direct the oxidant and the raw product gas into the reactor.

7. The gasifier system according to claim 1, wherein the reactor further comprises an outlet to remove solid particulates from the reactor.

8. The gasifier system according to claim 1, further comprising a partial oxidation reactor coupled to the recycle conduit.

9. A method for converting a carbonaceous stream into a product gas in a gasifier system, the method comprising the steps of:
providing a carbonaceous feedstock via an inlet disposed in an upper section of a reactor;
providing an oxidant via an oxidant inlet disposed in a lower section of the reactor;
reacting the stream of the carbonaceous feedstock and the oxidant, to form a mixture comprising raw product gas, product gas, and solid particulates;
transferring the raw product gas, via at least one raw product gas outlet disposed within the upper section of the reactor, to a recycle conduit;
recycling at least a portion of the raw product gas to the reactor, via the recycle conduit; and
transferring the product gas out of the reactor, to a desired location, via at least one product gas outlet located in a central section of the reactor.

10. The method according to claim 9, wherein the carbonaceous feedstock comprises biomass.

11. The method according to claim 9, wherein the carbonaceous feedstock comprises a mixture of coal and biomass.

12. The method according to claim 9, wherein reacting the carbonaceous feedstock and the oxidant is carried out at a temperature in a range of about 600° C. to about 1100° C.

13. The method according to claim 9, wherein reacting the carbonaceous feedstock and the oxidant is carried out at a pressure in a range from about 1 to about 5.

14. The method according to claim 9, wherein the oxidant and the raw product gas are premixed before being introduced in the lower section of the reactor.

15. The method according to claim 9, wherein the oxidant and the raw product gas are introduced independently in the lower section of the reactor.

16. The method according to claim 9, wherein the product gas is discharged from the reactor at a temperature in a range from about 800° C. to about 1000° C.

17. The method according to claim 9, wherein the raw product gas is brought into thermal contact with the product gas exiting the reactor, through a heat exchange unit located downstream of the reactor.

18. The method according to claim 9, further comprising the step of separating the solid particulates via an outlet disposed in the lower section of the reactor.

19. The method according to claim 9, wherein the oxidant is selected from air, oxygen, a mixture comprising air and steam, a mixture comprising air and carbon dioxide; or a mixture comprising air, steam, and carbon dioxide.

20. A gasifier system which is configured to gasify a carbonaceous feedstock, said system comprising a reactor which includes at least one feedstock inlet and at least one raw product gas outlet, and further comprising a recycle conduit which is configured to recycle raw product gas exiting from one section of the reactor, for entry into another section of the reactor.
